(19) United States
(12) Patent Application Publication
(10) Pub. No.: US 2025/0043494 A1
(43) Pub. Date: Feb. 6, 2025

(54) LAUNDRY TREATING APPARATUS

(71) Applicant: LG ELECTRONICS INC., Seoul (KR)

(72) Inventors: Kanghun LEE, Seoul (KR); Dongkil CHOI, Seoul (KR); Hyeonjoong KIM, Seoul (KR); Woore KIM, Seoul (KR)

(73) Assignee: LG ELECTRONICS INC., Seoul (KR)

(21) Appl. No.: 18/715,039

(22) PCT Filed: Nov. 30, 2022
(86) PCT No.: PCT/KR2022/019252

§ 371 Date: May 30, 2024

(30) Foreign Application Priority Data
Nov. 30, 2021 (KR) 10-2021-0168425

(51) Int. Cl. D06F 37/40; D06F 37/26; D06F 39/04; D06F 39/08; D06F 58/08

(52) U.S. Cl. CPC D06F 37/40; D06F 37/264; D06F 39/04; D06F 39/088; D06F 58/08

(57) ABSTRACT

Provided is a laundry treating apparatus including a cabinet having an inlet disposed in a front surface thereof, a tub having a tub inlet disposed therein and facing the inlet of the cabinet, wherein the tub is configured to accommodate water therein, a drum disposed inside the tub, and configured to accommodate laundry therein, a driver including a rotation shaft coupled to a rear of the tub and configured to rotate the drum, and, an induction module coupled to an outer circumferential surface of the tub that is configured to form a magnetic field for heating the drum. The induction module includes a base coupled to the outer circumferential surface, and a coil configured to generate the magnetic field. The base includes a seating surface fixed to the outer circumferential surface of the tub, a plurality of first straight ribs, a plurality of second straight ribs, and a plurality of curved ribs.

### CROSS-REFERENCE TO RELATED APPLICATIONS

This application is a national stage filing of PCT App. No. PCT/KR2022/019252, filed on Nov. 30, 2022, which claims the priority benefit of Korean Patent Application No. 10-2021-0168425 filed in the Republic of Korea on Nov. 30, 2021, which are hereby incorporated by reference as if fully set forth herein.

### BACKGROUND

### 1. Field of the Invention

The present disclosure relates to a laundry treating apparatus.

### 2. Description of the Related Art

In general, laundry treating apparatuses may include a washing machine with for washing laundry, a dryer for drying laundry, and a refresher for refreshing laundry.

In the laundry treating apparatus, the washing refers to a process of removing contaminants from clothes by adding water and detergent and using a mechanical action, and the drying refers to a process of removing moisture contained in wet laundry.

A laundry treating apparatus of the related art is configured to heat the laundry or water in order to increase a washing efficiency or dry the laundry.

In the related art laundry treating apparatus, a heater is directly inserted into a tub for accommodating water therein so as to heat water, or the laundry and water are heated in a scheme of supplying hot air into a drum for accommodating the laundry therein.

However, because heating water with the heater must satisfy an essential condition that the heater must always be submerged in water, there is a fundamental limitation that the laundry is not able to be heated when there is no water.

In addition, supplying the hot air to the drum has a problem in that a configuration is complicated because a duct through which the hot air is circulated or supplied requires a heat pump system that separately heats the air in the duct. Additionally, there is a problem that the laundry or water is not able to be heated with the hot air when water is contained inside the drum.

In order to solve such problem, recently, a laundry treating apparatus that directly heats a drum made of a metal material via an induced current has appeared (see Korean Patent Publication Application No. 10-2018-0023276).

FIG. 1 shows a related art laundry treating apparatus that directly heats the drum via the induced current. Referring to FIG. 1(a), the laundry treating apparatus may include a tub 20 for accommodating a drum 30 made of a metal material therein, and an induction module 70 coupled to the tub to generate the induced current in the drum. The induction module 70 may generate an induced magnetic field so as to generate an eddy current in the drum, and heat the drum itself as the eddy current generated in the drum is converted into thermal energy.

Accordingly, the related art laundry treating apparatus is able to dry the laundry or heat water by heating the drum as needed, regardless of whether the drum is submerged in water or not.

The induction module 70 was able to be coupled to and fixed to the tub 20. Because the tub 20 is made of a plastic material, the magnetic field generated by the induction module I was able to be transmitted to the drum as it is.

FIG. 1(b) shows a structure in which a coil is wound in the induction module 70 in the related art laundry treating apparatus. The induction module 70 may include a base 741 coupled to the tub 20, ribs 742 protruding from a top surface of the base 741 and around which the coil is wound, and a coupling portion 743 for coupling the base 741 to the tub 20.

In the induction module 70, the coil may be wound only around the ribs 742, and the coil may not be wound in a region of the base 741 located outwardly of the ribs 742. Each rib 742 may include a first straight portion 7421 around which the coil is disposed in a straight line along a longitudinal direction of the tub, a second straight portion 7422 around which the coil is disposed in a straight line along a circumferential direction of the tub, and a curved portion 7423 for connecting the first straight portion and the second straight portion to each other.

Referring to FIG. 1(c), radii of curvature of the curved portions 7423 of the respective ribs increase in an outward direction. For example, when the plurality of curved portions 7423 are formed to be spaced apart from each other as an inner curved portion a, middle curved portion b, and an outer curved portion c, a radius of curvature R3 of the outer curved portion c is greater than a radius of curvature R2 of the middle curved portion b, and the radius of curvature R2 of the middle curved portion b is greater than a radius of curvature R1 of the inner curved portion c.

Accordingly, radii of curvature of windings of the coil respectively wound around the inner curved portion a, the middle curved portion b, and the outer curved portion c are also different from each other, so that a uniform magnetic field is not able to be generated in the entire curved portions 7423.

In other words, lengths of the windings of the coil 600 respectively wound around the inner curved portion a, the middle curved portion b, and the outer curved portion e increase in the outward direction, and areas of the windings of the coil 600 forming curved lines for each unit area also increase as it goes toward the inner curved portion a, the middle curved portion b, and the outer curved portion c, so that there was a problem that a uniform magnetic field is not generated in the curved portions 7423 in the outward direction. As a result, the portion of the drum 30 facing the curved portions 7423 is not able to be uniformly heated.

Next, the first straight portions 7421 are spaced apart from each other by a spacing equal to a spacing at which the second straight portions 7422 are spaced apart from each other, so that portions of respective windings of the coil wound around the respective first straight portions 7421 are spaced apart from each other by a spacing equal to a spacing at which portions of the respective windings of the coil wound around the respective second straight portions 7422 are spaced apart from each other.

Accordingly, the portions of the respective windings of the coil 600 wound around the respective first straight portions 7421 and the portions wound around the respective second straight portions 7422 may generate the same amount of magnetic field for each unit area, and regions of the drum 30 respectively positioned corresponding to the first straight portions 7421 and the second straight portions 7422 may be heated evenly.

However, because the curved portion 7423 for connecting the first straight portion 7421 and the second straight portion 7422 to each other curves, there is a problem in that the magnetic field is not generated in a corner region of the base 741 disposed outwardly of the curved portion 7423 and disposed inwardly of extension lines of the first straight portion 7421 and the second straight portion 7422.

Accordingly, there is a problem in that a region of the drum 30 corresponding to the corner region of the base 741 is not sufficiently heated because the magnetic field is not transmitted thereto.

When the outer curved portion c is disposed to be biased toward the corner of the base 741 so as to cover more of the corner region of the base 741 as in FIG. 1(d) in order to solve such problem, a spacing L2 between the outer curved portion c and the middle curved portion b becomes different from a spacing L1 between the inner curved portion a and the middle curved portion b.

As a result, when the curved portion 7423 is further extended to cover the corner region of the base 741 in a state in which the diameter of the coil 600 is uniform, the spacing between the curved portions 7423 becomes non-uniform, and a magnetic field is not able to be uniformly generated.

As a result, there is a problem that the drum 30 is not able to be heated uniformly because the induced magnetic fields generated by the curved portions 7423 are not uniform due to the non-uniform spacing of the coil 600, or stability of the induction module 70 rapidly decreases as the coil 600 is not being able to be fixed and shakes or vibrates.

### SUMMARY OF THE DISCLOSURE

### Technical Problem

The present disclosure provides a laundry treating apparatus for heating a drum with an induced magnetic field generated from a coil in which spacings between windings of the coil wound in a curved region may be maintained uniformly.

Additionally, the present disclosure provides a laundry treating apparatus in which lengths of windings of a coil wound in a curved region may be maintained uniformly.

Further, the present disclosure provides a laundry treating apparatus in which density of windings of a coil wound in a curved region may be maintained uniformly.

### Technical Solution

In the present disclosure, inner and outer windings of a curved portion of a coil wound on an induction module for heating a drum may be uniformly spaced apart from each.

In addition, the inner and outer windings of the curved portion of the coil may be formed in the same shape.

As a result, it is possible to induce a uniform magnetic field to be generated in the entire curved portion of the coil in the induction module, thereby increasing heating uniformity.

Specifically, a radius of curvature of an outer surface of a curved rib around which the curved portion of the coil is wound and a radius of curvature of an inner surface of the curved rib may be different from each other.

Specifically, the radius of curvature of the outer surface of the curved rib is smaller than the radius of curvature of the inner surface, so that the radius of curvature, which may increase in an outward direction, may be compensated for and maintained.

As a result, a thickness of the curved ribs may be different from a thickness of straight ribs around which a straight portion of the coil is wound.

Specifically, the plurality of curved ribs may have a thickness different from that of at least one of first straight ribs disposed in a longitudinal direction of the drum and second straight ribs disposed in a circumferential direction of the drum.

Each of the plurality of curved ribs may have a portion having a greater thickness than the first straight rib and the second straight rib.

Each of the plurality of curved ribs may have a central portion thicker than end portions thereof respectively connected to the adjacent first straight rib and the adjacent second straight rib.

Each of the plurality of curved ribs may be configured such that the thickness thereof increases and then decreases while extending from the adjacent first straight rib to the adjacent second straight rib.

A radius of curvature of the curved rib disposed at the inner side of the seating surface and a radius of curvature of the curved rib disposed at the outer side of the seating surface may be equal to each other.

A radius of curvature of an inner surface of the curved rib disposed at the inner side of the seating surface and a radius of curvature of an inner surface of the curved rib disposed at the outer side of the seating surface may be equal to each other.

A radius of curvature of an outer surface of the curved rib disposed at the inner side of the seating surface and a radius of curvature of an outer surface of the curved rib disposed at the outer side of the seating surface may be equal to each other.

A length of the curved rib disposed at the inner side of the seating surface and a length of the curved rib disposed at the outer side of the seating surface may be equal to each other.

A shape of the curved rib disposed at the inner side of the seating surface and a shape of the curved rib disposed at the outer side of the seating surface may be equal to each other.

An extended line of one ends of the plurality of curved ribs may form a first straight line, and an extended line of the other ends of the plurality of curved ribs may form a second straight line parallel to the first straight line.

A spacing between the first straight line and the second straight line may be maintained in the outward direction of the seating surface.

The first straight rib and the second straight rib may be configured such that lengths thereof increase in the outward direction of the seating surface.

The first straight rib and the second straight rib may be configured such that lengths thereof increase at a predetermined rate in the outward direction of the seating surface.

### Advantageous Effects

The present disclosure may uniformly maintain the spacings between the windings of the coil wound in the curved region in the laundry treating apparatus for heating the drum with the induced magnetic field generated from the coil.

Additionally, the present disclosure may uniformly maintain the lengths of windings of the coil wound in the curved region.

Further, the present disclosure may uniformly maintain the density of the windings of the coil wound in the curved region.

In addition, the present disclosure may provide an optimal position capable of securing stability of coupling of the ribs.

### BRIEF DESCRIPTION OF THE DRAWINGS

FIG. 1 shows an induction arrangement of a related art laundry treating apparatus.

FIG. 2 shows a structure of a laundry treating apparatus according to the present disclosure.

FIG. 3 shows an induction module of a laundry treating apparatus according to the present disclosure.

FIG. 4 shows a base structure of an induction module according to the present disclosure.

FIG. 5 shows a structure in which a coil is wound in an induction module according to the present disclosure.

FIG. 6 shows a structure configured to install permanent magnets in an induction module according to the present disclosure.

FIG. 7 shows a coil structure of an induction module according to the present disclosure.

FIG. 8 shows a shape of an induction module of a laundry treating apparatus according to the present disclosure.

FIG. 9 shows a principle of an induction module of a laundry treating apparatus according to the present disclosure.

FIG. 10 shows an overall shape of an induction module of a laundry treating apparatus according to the present disclosure.

FIG. 11 is a front view of an induction module of a laundry treating apparatus according to the present disclosure.

FIG. 12 is an enlargement view of a curved portion of an induction module of a laundry treating apparatus according to the present disclosure.

FIG. 13 shows a shape of a wound coil of a laundry treating apparatus according to the present disclosure.

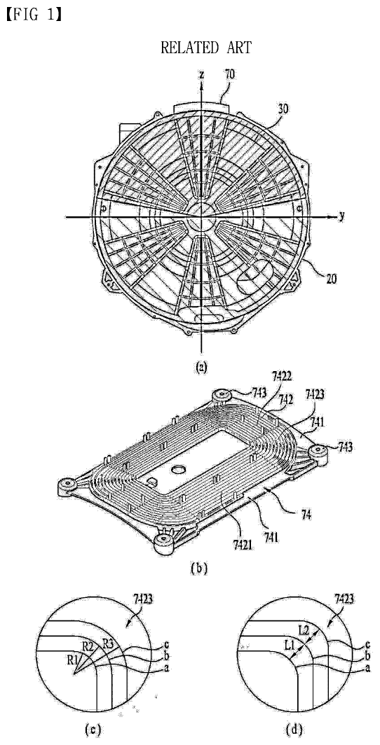

### DETAILED DESCRIPTION

Hereinafter, embodiments disclosed herein will be described in detail with reference to the accompanying drawings. Herein, the same or similar reference numerals are assigned to the same or similar components even in different embodiments, and a description of the same or similar components is replaced with the first description. Singular expressions used herein include plural expressions unless the context clearly dictates otherwise. In addition, in describing the embodiment disclosed herein, when it is determined that detailed descriptions of related known technologies may obscure the gist of the embodiment disclosed herein, the detailed descriptions thereof will be omitted. In addition, it should be noted that the accompanying drawings are only for easy understanding of the embodiment disclosed herein, and do not limit the technical idea disclosed herein.

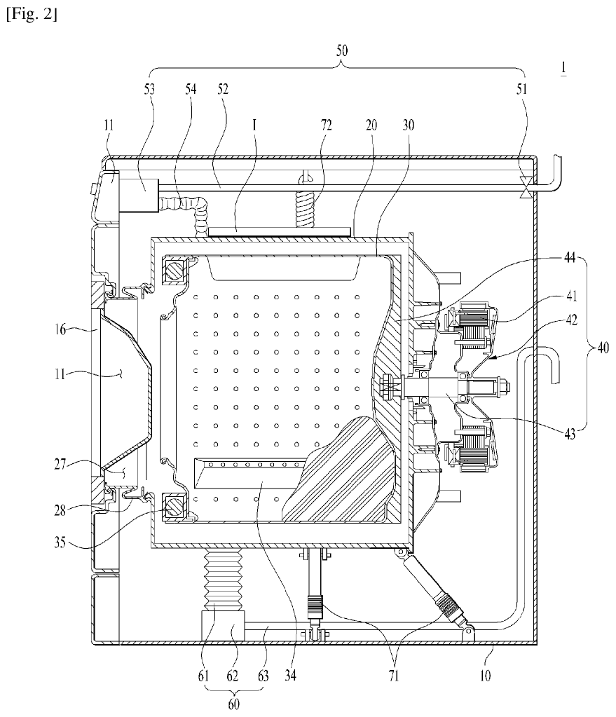

FIG. 2 shows a configuration of a laundry treating apparatus 1 according to the present disclosure. A laundry treating apparatus 1 according to the present disclosure may include a cabinet 10 that forms an outer appearance of the apparatus, a tub 20 disposed inside the cabinet, and a drum 30 that is rotatably accommodated inside the tub 20. The drum 30 may be configured to accommodate laundry (or an object-to-be-dried or an object-to-be-refreshed) therein.

The cabinet 10 may include an inlet 17 defined in a front surface of the cabinet 10 and through which the laundry (or the object-to-be-dried or the object-to-be-refreshed) is inserted into or withdrawn from. The cabinet 10 may include a door 16 pivotably mounted on the cabinet so as to open and close the inlet 17.

The door 16 may include an annular door frame 161 and a viewing window 162 disposed at a central portion of the door frame. The tub 20 is formed in a cylindrical shape with a longitudinal axis parallel to or maintaining an angle of approximately 0 to 30° with a bottom surface of the cabinet so as to define a space in which water may be stored. Additionally, the tub 20 may include a tub inlet 27 defined in a front surface thereof which communicates with the inlet 17.

The tub 20 may be supported by a support 70 and fixed inside the cabinet 10. Additionally, the support 70 may include a damper 71 for supporting a bottom surface of the tub 20 and a spring 72 for supporting a top surface of the tub 20. However, the configuration is not limited thereto. For example, the tub 20 can include a plurality of springs 72 on any of the side surfaces, or a plurality of dampers 71 on any of the side surfaces.

Accordingly, vibration transmitted to the tub 20 by rotation of the drum 30 may be attenuated via the damper 71 and the spring 72.

The drum 30 is formed in a cylindrical shape with a longitudinal axis parallel to or maintaining an angle of approximately 0 to 30° with the bottom surface of the cabinet configured to accommodate the laundry (or the object-to-be-dried or the object-to-be-refreshed) therein, and has a drum inlet 31 defined in a front surface thereof so as to be in communication with the tub inlet 27.

Therefore, a user may put the laundry (or the object-to-be-dried or the object-to-be-refreshed) into an inner space of the drum 30 via the inlet 17, the tub inlet 27, and the drum inlet 31, or withdraw the laundry (or the object-to-be-dried or the object-to-be-refreshed) from the inner space of the drum 30.

In addition, the drum 30 may include a drum outer circumferential surface 32 for accommodating the laundry therein and a drum rear surface 33 disposed at the rear of the drum and coupled to a driver 40. The drum outer circumferential surface 32 includes multiple through-holes 321 defined therein. This is to allow water stored in the tub 20 to flow into the drum as well as to allow water discharged from the laundry (or the object-to-be-dried or the object-to-be-refreshed) to be discharged to an inner space of the tub 20.

A lifter 34 for stirring the laundry (or the object-to-be-dried or the object-to-be-refreshed) when the drum rotates may be further disposed on an inner circumferential surface of the drum 30.

In addition, the drum 30 may further include a balancer 35 coupled to the drum outer circumferential surface 32 from the front so as to compensate for eccentricity inside the drum 30. A plurality of balls or fluid having a mass configured to compensate for the eccentricity may be accommodated inside the balancer 35.

The laundry treating apparatus 1 according to the present disclosure may include the driver 40 for rotating the drum 30. The driver 40 may be coupled to the tub 20 so as to rotate the drum 30. The driver 40 may include a stator 41 fixed to a rear surface of the tub 20 so as to generate a rotating magnetic field, a rotor 42 that rotates by an electromagnetic action with the stator, and a rotation shaft 43 that extends through the rear surface of the tub 20 and connects the drum rear surface 33 and the rotor 42 to each other. In addition, the driver 40 may further include a spider 44 coupled to the drum rear surface 33 so as to rotate the drum 30.

The spider 44 may be configured to surround one end of the rotation shaft 43, and one surface thereof may be coupled to the drum rear surface 33 and may be coupled to the rotor 42 via the rotation shaft 43.

Further, the laundry treating apparatus 1 according to one embodiment of the present disclosure may further include water supply means 50 for receiving water from an outside of the laundry treating apparatus 1.

The water supply means 50 may include a water supply valve 51 coupled to the cabinet 10 and in communication with an external water supply source, a water supply pipe 52 extending from the water supply valve 51 and configured to receive water, a detergent box 53 configured to receive water from the water supply pipe 52 and store detergent therein, and a supply pipe 54 that supplies at least one of water and detergent to the tub 20 by connecting the detergent box 53 and the tub 20 to each other.

The detergent contained in the detergent box 53 may be diluted with water introduced from the water supply pipe 52 and supplied to the tub 20 via the supply pipe 52. The detergent box 53 may include a housing fixed in a space between the top surface of the tub 20 and the cabinet 10, and a detergent accommodating portion configured to extend in a forward direction from and retracted into the housing.

The laundry treating apparatus according to one embodiment of the present disclosure may further include a drainage 60 that discharges water inside the tub 20 to the outside of the cabinet 10.

The drainage 60 may include a drain pipe 61 that discharges water from the tub 20, a drain pump 62 connected to the drain pipe 61 to provide power for discharging the water to the outside of the cabinet 10, and an extension pipe 63 extending from the drain pump 62 to the outside of the cabinet 10.

Additionally, the drain pump 62 and the drain pipe 61 are disposed below the tub 20 such that water in the tub 20 is more easily discharged by gravity.

Next, a gasket 28 may be disposed between the inlet of the cabinet 10 and the tub inlet 27. The gasket 28 may prevent water disposed inside the tub 20 from leaking into the cabinet 10. In addition, the gasket 28 may be made of an elastic material so as to prevent vibration of the tub 20 from being transmitted to the cabinet 10.

Further, the laundry treating apparatus 1 according to the present disclosure may include an input panel 11 configured to receive a command to operate the laundry treating apparatus 1. The input panel 11 may be disposed on a front surface of the laundry treating apparatus 1, but is not limited thereto. In addition, the input panel 11 may be configured to receive a series of commands for supplying power to the laundry treating apparatus or for the laundry treating apparatus to perform a washing course or a drying course for washing or drying the laundry. Additionally, the user may input other commands into the input panel 11. For example, the user may control a duration and a temperature of the washing course and drying course.

The input panel 11 may be formed as a user interface and may include display means such as a liquid crystal or a light to display information of the laundry treating apparatus.

Next, the laundry treating apparatus 1 according to the present disclosure may be configured to perform the heating of water, and drying and refreshing (steam treatment) of the laundry (or the object-to-be-dried or the object-to-be-refreshed). To this end, the laundry treating apparatus 1 according to the present disclosure may include an induction module I for heating the drum 30.

The induction module I may be utilized when performing at least one function of the washing, the drying, and the refreshing.

The induction module I may be mounted on the outer circumferential surface of the tub 20, and a coil 600 formed by winding an electric wire may be installed inside the induction module I. The induction module I is configured to heat the circumferential surface of the drum 30 via a magnetic field generated by applying a current to the coil 600.

The magnetic field may be generated via an alternating current whose phase changes flows to the coil 600 located outwardly of the circumferential surface of the drum 30. For example, the coil 600 may form a radial alternating magnetic field based on the Ampere's circuital law.

Such alternating magnetic field is concentrated around the drum 30 made of a conductor with high magnetic permeability. Magnetic permeability as used herein refers to an extent to which a medium is magnetized with respect to a given magnetic field. In this regard, based on the Faraday's law of induction, an eddy current is formed on the drum 30. Such eddy current flows along the drum 30 made of the conductor and then is converted into Joule heat by a resistance of the drum 30 itself, and accordingly, an inner wall of the drum 30 is directly heated. Accordingly, laundry or water inside the drum 30 can be heated. For example, when the inner wall of the drum 30 is directly heated, an air temperature inside the drum 30 and a temperature of the laundry in contact with the inner wall of the drum 30 rise together. Accordingly, because the laundry may be directly heated, drying may be performed faster compared to a drying apparatus using only hot air, which is an indirect method of heating the laundry, or a low-temperature dehumidifying method of drying the laundry.

In addition, even when the laundry treating apparatus 1 according to the present disclosure is formed to operate as both a washing machine and a dryer, water may be heated without a separate heat wire and flow channel exposed inside the tub 20, and water may continuously come into contact with the inner and outer walls of the drum 30. Therefore, faster water heating may be achieved compared to a method in which the separate heater is formed at a lower portion of the tub 20 and water is heated using the heater.

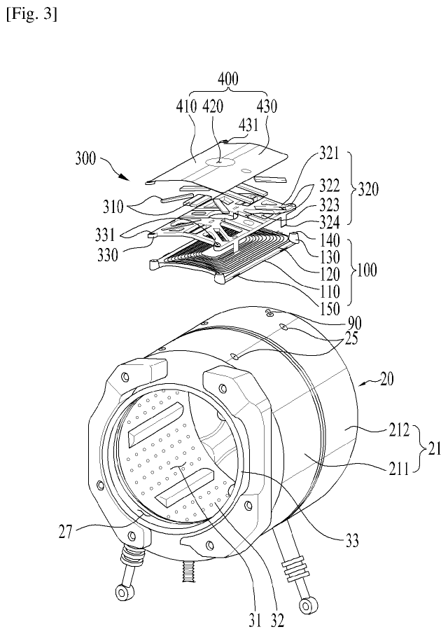

FIG. 3 shows an embodiment of the induction module I of the laundry treating apparatus according to the present disclosure.

The induction module I is mounted on the circumferential surface of the tub 20 and is configured to heat the circumferential surface of the drum 30 via the magnetic field generated by applying a current to the coil 600 around which the wire is wound.

The induction module I may include a base 100 for installing the coil 600 on a top surface of the tub 20. The base 100 may be fixed to the circumferential surface of the tub 20, and may extend through the rotation shaft 43. In addition, the base 100 may be disposed on a horizontal surface parallel to the ground. The base 100 may be formed in a rectangular plate shape or rectangular shape having a predetermined thickness, and a length in the front and rear direction thereof may be greater than a width corresponding to a circumferential direction of the tub 20.

The base 100 may include a base body 110 that may be disposed on the outer circumferential surface of the tub 20, a seating surface 120 disposed on a top surface of the base body 110 and on which the coil 600 is wound, a bottom surface 130 disposed on a bottom surface of the base body 110 and facing the outer circumferential surface of the tub 20, and a fixing portion 140 for coupling the base body 110 to the outer circumferential surface of the tub 20.

At least one of the base body 110 and the seating surface 120 may have a curved cross-section so as to concentrate a magnetic field generated from the coil 600 to the drum 30. In addition, the base 100 may have seating ribs 200 protruding upward from the seating surface 120 and on which the coil is wound. The seating ribs 200 may extend outwardly from the seating surface 120 like a screw which defines an installation space 230 for the coil 600, in which the coil 600 is seated or inserted.

In order to concentrate the magnetic field generated by the coil 600 toward the drum 30 rather than the cabinet 10, the induction module I may include a magnet 310 that is disposed on the base 100 and is a bar magnet, and a magnet cover 320 for fixing the magnet 310 to the base 100 from above.

Multiple magnets 310 may be arranged so as to be spaced apart from each other along a direction in which the coil 600 is wound. The magnet 310 may be located above the coil 600, but may be disposed perpendicular to a longitudinal direction of the wire constituting the coil 600 so as to be simultaneously disposed above an inner portion and an outer portion of the coil.

The magnet cover 320 may further include a housing body 321 having a rectangular plate shape or rectangular shape with a predetermined thickness corresponding to the shape of the base 100, a magnet installation portion 322 defined on the housing body 321 and in which the magnet 310 is seated, and an air flow hole 323 defined to extend through the housing body 321 and spaced apart from the magnet installation portion 322.

The magnet installation portion 322 may determine a space in which the magnet 310 is accommodated and installed.

The induction module I may include a base cover 400 for fixing the magnet cover 320 to the base 100 and preventing the coil 600 from deviating. The base cover 400 may include a cover body 410 having a rectangular plate shape or rectangular shape with a predetermined thickness, and an air discharge hole 420 defined in a central portion of the cover body 410 and through which hot air flows by convection or is blown by a blowing fan 500.

The blowing fan 500 that supplies air into the induction module I may be coupled to the base cover 400. The blowing fan 500 allows air to flow into the induction module I so as to prevent overheating of the induction module I. Specifically, air may be introduced into the base cover 400 via the air discharge hole 420. Inside the induction module, a space is defined between the base cover 400, a magnet coupling portion 300, and the base 100, and an air flow space is defined by an air flow hole 323 or the like. In addition, an air passing hole 111 is defined in the base body 110. Thus, air may cool the coil 600 in the inner space and may be discharged to the outside of the induction module via the air passing hole 111.

In addition, because the magnet cover 320 and the base cover 400 are formed as separate members, air may flow on a top surface of the magnet 310. Thus, overheating of the magnet 310 may be prevented.

In addition, because the magnet cover 320 and the base cover 400 are formed as the separate members, the magnet 310 may be easily detachable and easily exchanged, and a part fixing the magnet 310 may be easily injection-molded because of not having a closed surface.

Hereinafter, a structure for fixing the base 100, the magnet cover 320, and the base cover 400 to the tub 20 will be described in more detail.

The base 100 may include the fixing portion 140 disposed at a corner of the base body 110 and having a fixing hole 141 defined therein into which a screw is inserted. The fixing portion 140 may be configured to protrude from each of both sides of front and rear ends of the base body 110.

The tub 20 may include multiple coupling portions 25. The coupling portions 25 may be a hole configured to communicate with the fixing hole 141.

In addition, the magnet cover 320 may include a magnet fixing portion 330 disposed at a corner of the housing body 321. The magnet fixing portion 330 may include a magnet fixing hole 321 defined therein to communicate with the fixing hole 141 and into which the screw is inserted. Further, the magnet fixing portion 330 may protrude from each of both sides of front and rear ends of the housing body 321.

In addition, the base cover 400 may include a cover fixing portion 430 protruding from each of front and rear ends of the cover body 410 and having a cover fixing hole 431 defined there in communication with the fixing hole 141.

Accordingly, one screw may extend through the cover fixing hole 431, the magnet fixing hole 331, and the fixing hole 141. Additionally, the one screw can be fixed to the coupling portion 25.

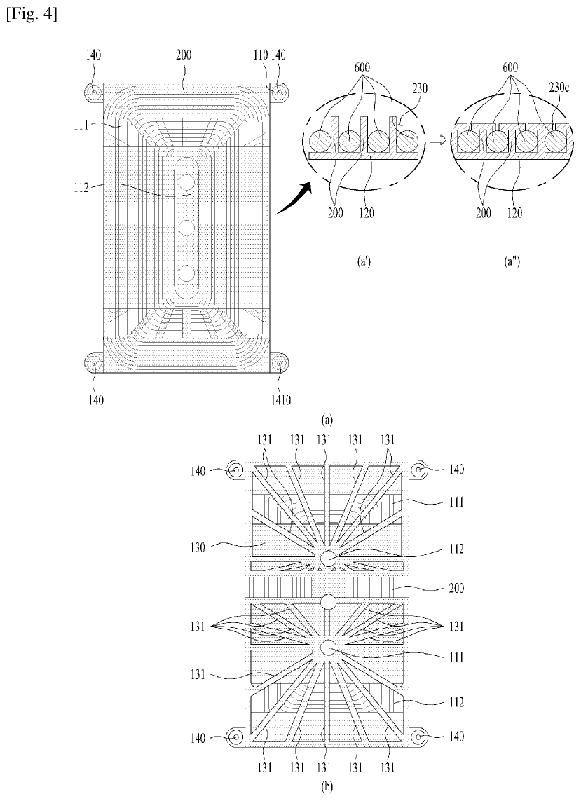

FIG. 4 shows the base 100 of the induction module. The induction module I may serve as a fixing member for fixing the coil 600 to the outer circumferential surface of the tub 20, and may include the base 100 mounted on the outer circumferential surface of the tub 20 such that the coil 600 does not deviate even when the tub 20 vibrates.

FIG. 4(a) shows a top surface of the base 100, and FIG. 4(b) shows a bottom surface of the base 100.

Referring to FIG. 4(a), the base 100 may include the base body 110 disposed on the outer circumferential surface of the tub 20, the seating surface 120 disposed such that the coil 600 is seated on the top surface of the base body 110, and the seating ribs 200 protruding from the seating surface 120 and fixed as the coil 600 is wound thereon. The base body 110 may have the air passing hole 111 defined in a thickness direction.

The seating ribs 200 may extend to a top surface of the air passing hole 111. For example, the seating ribs 200 may be formed on the seating surface 120 regardless of a shape of the air passing hole 111. Additionally, the seating ribs 200 may extend outwardly along a circumference of the seating surface 120.

When extending outwardly, the seating ribs 200 may be spaced apart from each other by a certain spacing so as to define the installation space 230 in which the coil 600 is installed therebetween. The seating ribs 200 may extend outwardly along a shape of a circle or an ellipse whose diameter gradually increases outwardly on the seating surface. In addition, the seating ribs 200 may extend in a track shape with an area increasing outwardly of the seating surface. The track shape is a shape in which a straight portion and a curved portion are each present at different portions of the seating ribs 200. The track shape may mean a shape capable of maximizing an area in which the coil 600 is seated of the seating surface 120 compared to the circular or elliptical shape.

A shape in which the coil 600 is wound may be determined based on the shape in which the seating ribs 200 extend from the seating surface 120. For example, the shape of the coil 600 may be circular, elliptical shaped, or track shaped.

The seating rib 200 may protrude or extend from the seating surface 120, and may have a height greater than a thickness of the coil 600. The seating ribs 200 may allow turns of the wound coil 600 to be spaced apart from each other so as not to be in contact with each other, thereby preventing a short circuit. As a result, it is not necessary to coat the coil 600 wound on the seating ribs 200 with an insulating film. Additionally, a thickness of the insulating film is able to be minimized, thereby reducing a production cost.

The seating ribs 200 may include slots narrower than a wire diameter of the coil 600 such that the coil 600 is tight-fitted, and a width of the installation space 230 may be in a range from approximately 93% to 97% of the wire diameter of the coil 600. When the coil 600 is tight-fitted into the installation space 230, even though the vibration of the tub 20 is transmitted to the coil 600, the coil 600 may be fixed in the installation space 230. Therefore, the coil 600 does not depart from the installation space 230, and a movement of the coil 600 itself is suppressed, so that noise that may occur due to a gap between the coil 600 and the seating ribs 200 may be prevented.

In one example, upper ends of the seating rib 200 may be bent after the coil 600 is inserted so as to shield at least a portion of a top portion of the coil 600. To this end, the upper ends of the seating ribs 200 may be bent or heat-treated. For example, the upper ends of the seating ribs 200 may be bent into a “T” shape. Thus, the upper end of the seating rib 200 may form a fixing hook 221 for fixing the coil 600.

Referring to FIG. 4(a), after the coil 600 is tight-fitted into the installation space 230, the seating rib 200 may be melted as a top surface thereof is pressurized. Then, the melted upper end of the molten seating rib 200 may spread to both sides so as to cover top surfaces of turns of the coil 600 on both sides. Accordingly, the coil 600 can be encased by the molten seating rib 200.

As the coil 600 is tight-fitted into the installation space 230 and the upper end of the seating rib 200 is melted, a path along which the coil 600 may deviate may be physically blocked, and noise caused by the vibration of the tub 20 may be prevented by preventing the movement of the coil 600. Therefore, durability may be improved as a gap between parts is eliminated.

In the above description, it is assumed that the coil 600 is disposed on the top surface of the base 100, but the seating rib 200 may protrude downwardly of the base 100 such that the coil 600 is disposed on the bottom surface of the base 100.

FIG. 4(b) shows the bottom surface of base 100. The air passing hole 111 may be exposed to the bottom surface 130 of the base 110. In addition, a support bar 131 may be disposed on the bottom surface of the base 110. The support bar 131 may be configured to reinforce adhesion between the outer circumferential surface of the tub 20 and the base 100 and to reinforce rigidity of the base 100.

The base 100 may have a through-hole 112 disposed at a center of the seating surface 120 where the coil 600 is not wound, and the through-hole 112 may include a plurality of through-holes spaced apart from each other by a predetermined spacing along the front and rear direction of the tub 20. In addition, the support bar 131 may radially extend from the through-hole 112 extending through the base 100.

When the fixing portion 140 is fixed to the coupling portion 25 disposed on the outer circumferential surface of the tub 20, the outer circumferential surface of the tub 20 is pressurized by the support bar 131. Accordingly, the base 100 may be coupled to the tub 20 with a greater pressure compared to a case in which the entire bottom surface of the base 100 is in contact with the outer circumferential surface of the tub 20. Accordingly, even when the tub 20 vibrates, a base housing does not easily move or escape from the outer circumferential surface of the tub 20.

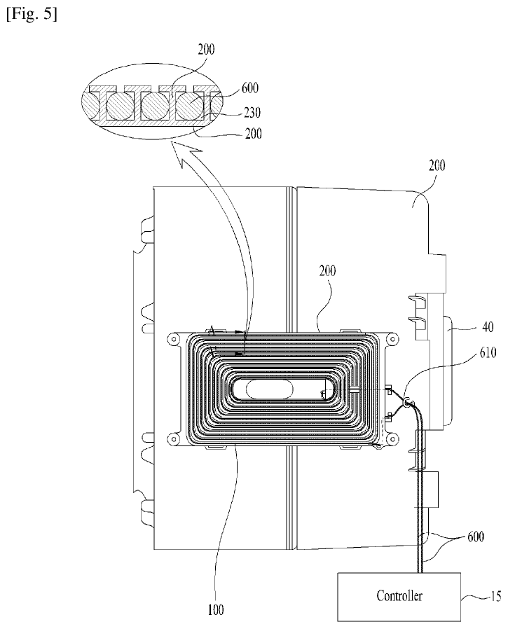

FIG. 5 shows a structure of the coil 600 of the induction module.

The seating ribs 200 may be formed from a position adjacent to an outermost edge of the seating surface 120 toward a center thereof, and each turn of the coil 600 may be wound between the adjacent two seating ribs 200.

Referring to the zoomed in portion of FIG. 5, the wire constituting the coil 600 may be tight-fitted by being in surface contact with the two adjacent seating ribs 200.

The laundry treating apparatus 1 according to the present disclosure may include a control panel 15 that is configured to control the supply of the current to the coil 600. Additionally, both ends of the coil 600 may be coupled to the control panel 15. One end of the coil 600 may extend toward the through-hole 321 disposed at the center of the seating surface 120, and an other end thereof may extend on the seating surface 120 toward the outermost edge of the seating rib 200.

The coil 600 may extend from the control panel 15 toward the seating surface 120 via the bottom surface 130 of the base body 110, be wound on the seating ribs 200, and then be connected to the control panel 15.

Accordingly, the coil wound on the seating ribs 200 may extend to the bottom surface 130 and then be connected to the control panel 15. This has an effect of preventing disconnection and deviation problems by reducing a vibration phase difference generated along a wire 81a by allowing the coil 600 to be connected to the base 100 via the bottom surface, which is a point where a vibration displacement of the outer circumferential surface of the tub 20 is the smallest.

In one example, both ends of the coil 600 may extend to a rear portion of the tub 20 and extend to the control panel 15. This configuration has the benefit that a vibration amplitude is small at the rear portion of the tub 20 because of the close proximity to the driver 40.

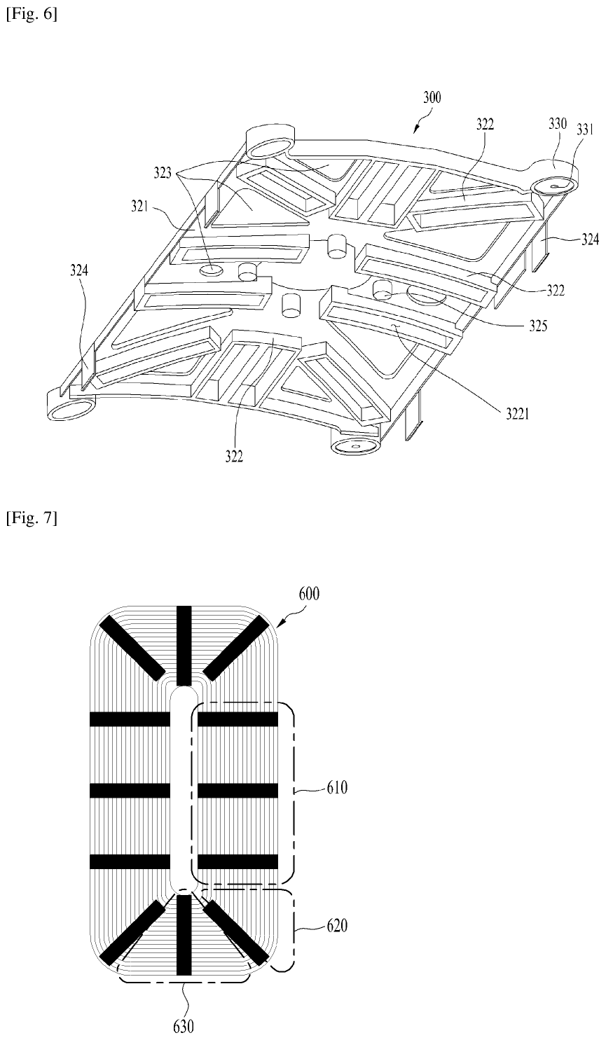

FIG. 6 shows a detailed structure of the magnet cover 320.

The induction module I may further include the magnet cover 320 coupled to the base 100 so as to cover the installation space 230. The magnet cover 320 may include a housing body 321 configured to be coupled to the top surface of the base 100 and preventing the coil 600 and the magnet 310 from deviating. A bottom surface of the housing body 321 may be formed to be in close contact with the upper ends of the seating ribs 200 of the base 100.

A plurality of magnet installation portions 322 protruding downwards may be defined on a bottom surface of the magnet cover 320. The magnet installation portion 322 may provide a space for accommodating the magnet 310 therein and, at the same time, may adhere closely to the upper end of the seating rib 320 so as to shield the seating rib 320 with a greater pressure. As a result, despite the vibration of the tub 20, the vibration noise caused by the gap or the deviation of the coil 600 may be prevented.

The plurality of magnet installation portions 322 may be arranged along the longitudinal direction of the coil 600. In addition, the magnet installation portion 322 may be formed perpendicular to the longitudinal direction of the coil 600. Therefore, the entire coil may be firmly fixed without pressing the entire coil.

In one example, the magnet installation portion 322 is formed integrally with the housing body 321. Therefore, at the same time as the magnet cover 320 is coupled to the base 100, the magnet installation portion 322 presses the coil 600. Therefore, a separate means or step for pressurizing the coil 600 is not required.

The magnet 310 may be inserted into and mounted in the magnet installation portion 322. Accordingly, when the magnet 310 is fixed to the magnet cover 320, the magnet may be fixed above the coil 600 as the magnet cover 320 is coupled to the base housing.

Because each magnet 310 is preferably disposed at a specific position on the top surface of the coil 600 in order to efficiently concentrate the magnetic field in a direction of the drum 30, when the magnet 310 moves by the vibration of the tub 20, not only the noise problem but also a problem of lowering a heating efficiency may occur.

More specifically, the magnet installation portion 322 may be formed of both side walls that protrude downward from the bottom surface of the magnet cover 320 which face each other, and may have an open surface 3221 such that a bottom surface of the magnet 310 mounted in the magnet installation portion 322 may face one surface of the coil 600.

In this case, a movement of the magnet 310 in a left and right direction may be suppressed by both of the side walls, and the open surface 3221 may allow the magnet 310 to come closer to the top surface of the coil 600. As the magnet 310 is closer to the coil 600, the magnetic field is guided more intensively in the direction of the drum 30. As a result, the drum 30 may be stably and uniformly heated.

The magnet installation portion 322 may further include a stopper protruding inward so as to prevent the magnet 310 from deviating downward. In one example, the magnet cover 320 may include detachable hooks 324 that protrude downward at both corners and are detachably coupled to the base 100.

FIG. 7 shows an arrangement of the coil 600 and the magnet 310 installed in the induction module I.

The coil 600 may be formed in the concentric circle, ellipse, or track shape on the outer circumferential surface of the tub 20. The track shape may include both straight portions and curved portions, with the curved portions being disposed to connect adjacent straight portions.

The magnet 310 acts as a blocking member for transmission of the magnetic field so as to prevent the heating of other nearby components other than the drum 30, and to increase the heating efficiency by concentrating the magnetic field generated by the coil 600 in the direction of the drum 30.

The magnet 310 may be formed as the bar magnet. The magnet 310 is located above the coil 600, but is preferably disposed perpendicular to the longitudinal direction of the coil 600. This is to cover the inner portion and the outer portion of the coil at the same time.

The magnet 310 may include a plurality of bar magnets having the same size, and the plurality of magnets 310 may be spaced apart from each other along the longitudinal direction of the coil 600.

This is because it difficult to perform the uniform heating as an amount of magnetic field radiated to the drum 30 varies for each portion of the circumferential surface of the drum 30 when the magnets 310 are placed only at specific positions. Therefore, in order to uniformly induce the magnetic field generated by the coil 600 in the direction of the drum 30, it is preferable that the plurality of magnets 310 are disposed to be spaced apart from each other along the circumference of the coil 600.

Furthermore, when there are the same number of magnets 310, it is preferable that the magnets 310 are intensively disposed in portions of the coil 600 adjacent to front and rear portions of the tub 20.

Specifically, the coil 600 may be divided into first straight portions 610 extending in a front and rear direction, curved portions 620 disposed at both ends of the straight portion, and second straight portions 630 disposed at front and rear portions of the coil 600. The first straight portion 610 may be longer than the second straight portion 630 so as to correspond to the length of the drum 30.

More permanent magnets may be disposed in the curved portion 620 and the second straight portion 630 than in the first straight portion 610. As a result, the drum 30 may be uniformly heated by allowing more magnetic field to be radiated to a region with a small area of the coil 600.

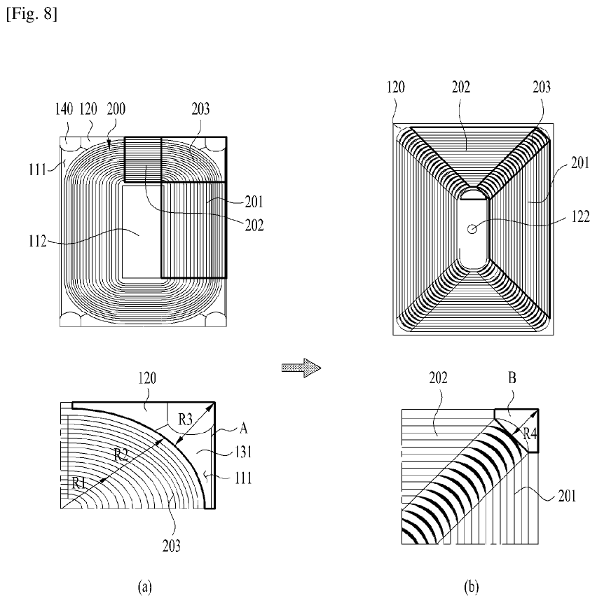

FIG. 8 shows a base structure of an induction module according to the present disclosure.

Referring to FIG. 8(a), the base 100 may include the seating surface 120, the air passing hole 111 extending through the seating surface, and the through-hole 112 extending through the center of the seating surface 120. Additionally, the seating ribs 200 outwardly extending along a circumference of the seating surface 120 may be disposed on top of the seating surface 120.

The base 100 has a length corresponding to the longitudinal direction of the tub greater than a width corresponding to the circumferential direction of the tub. In addition, because the coil 600 is configured to heat the drum outer circumferential surface 32 having the cylindrical shape where the length is greater than the width, the seating ribs 200 may be disposed in a region overlapping the outer circumferential surface 32 of the drum as much as possible. To this end, each seating rib 200 may include a first straight rib 201 extending in the longitudinal direction and a second straight rib 202 extending in the width direction. The first straight rib 201 may be disposed parallel to the rotation shaft along the longitudinal direction of the drum outer circumferential surface 32, and each second straight rib 202 may be disposed in a region corresponding to each of both ends of the first straight rib 201 so as to be disposed in a region corresponding to each of the front and rear portions of the drum. Additionally, each second straight rib 202 may be disposed at a position corresponding to each of front and rear portions of the drum outer circumferential surface.

Each seating rib 200 may include a curved rib 203 for connecting the first straight rib 201 and the second straight rib 202, which are adjacent thereto, to each other. The first straight rib 201, the second straight rib 202, and the curved rib 203 adjacent to each other may integrally extend to define an installation space in which the coil 600 is wound. The first straight rib 201, the second straight rib 202, and the curved rib 203 may respectively include a plurality of first straight ribs 201, a plurality of second straight ribs 202, and a plurality of curved ribs 203. The plurality of first straight ribs are spaced apart from each other in a region thereof in an outward direction of the seating surface, the plurality of second straight ribs are spaced apart from each other in a region thereof in an outward direction of the seating surface, and the plurality of curved ribs are spaced apart from each other in a region thereof in an outward direction of the seating surface. Each respective first straight rib 201 may connect to a respective curved rib 203. Additionally, the respective curved rib 203 may further connect to a respective second straight rib 202. Accordingly, one first straight rib 201 is configured to connect to one curved rib 203, and the one curved rib 203 is configured to connect to one second straight rib 202. Thus, the coil 600 may extend while being wound from an inner side to an outer side of the seating surface 120.

When the first straight ribs 201 have an equal length starting from an innermost first straight rib to an outermost first straight rib and the second straight ribs 202 have an equal length starting from an innermost second straight rib to an outermost second straight rib, lengths of the curved ribs 203 increase in the outward direction. In other words, the lengths and radii of curvature of the curved ribs 203 gradually increase from the inner side to the outer side of the seating surface 120. Accordingly, windings of the coil 600 respectively wound around the curved ribs 203 gradually increase in length and radius of curvature in the outward direction. That is, a radius of curvature r2 of an outermost curved rib 203 becomes greater than a radius of curvature r1 of a curved rib disposed in the middle.

As the radii of curvature of the curved ribs 203 increase, a first exclusion region A, in which the coil 600 does not pass, becomes larger and larger at a location near a corner of the seating surface 120. For example, as shown in FIG. 8(a), a maximum width of the first exclusion region may be a first exclusion width R3, which is a width corresponding to a region formed by the outermost curved rib 203 and edges of the seating surface 120.

As the first exclusion width R3 increases, a region of the drum outer circumferential surface 32 facing the corresponding region is not heated. As a result, the front and rear portions of the drum 32 are less heated than a central region of the drum 32, causing a problem that the entire drum 30 is not heated uniformly.

In order to reduce such problem, the laundry treating apparatus according to the present disclosure may allow one of the radii of curvature and the lengths of the curved ribs 203 to be uniform starting from the innermost curved rib to the outermost curved rib.

Referring to FIG. 8(b), the first straight ribs 201 are configured such that the lengths thereof increase in the outward direction of the seating surface 120, and the second straight ribs 202 are configured such that the lengths thereof increase in the outward direction of the seating surface 120.

Accordingly, an amount of increase in the lengths of the curved ribs 203 in the outward direction may be reduced or the lengths of the curved ribs 203 may be maintained uniform. In addition, an amount of increase in the radii of curvature of the curved ribs 203 in the outward direction may be reduced or the radii of curvature of the curved ribs 203 may be maintained uniform. Accordingly, the drum 30 may be more uniformly heated.

Additionally, as a result, an area of a second exclusion region B where the coil 600 does not pass at a location near the corner of the seating surface 120 may be gradually reduced, and the second exclusion region B may be formed smaller than the first exclusion region A.

For example, a maximum width of the second exclusion region may be a second exclusion width R4, which is a width corresponding to a region formed by the outermost curved rib 203 and the edges of the seating surface 120. The second exclusion width R4 may be smaller than the first exclusion width R3 due to the increase in the radii of curvature of the curved ribs 203.

As a result, a spacing between portions of the respective windings of the coil 600 disposed around the respective curved ribs 203 for each unit area may be maintained, and lengths of the portions of the respective windings disposed in each unit area may be maintained uniform as much as possible, so that more induced current may also be generated at the front and rear portions of the drum facing the curved ribs 203, thereby allowing heat to be generated more uniformly. Accordingly, all of the front portion, the rear portion, and the central portion of the drum 20 may be heated more uniformly.

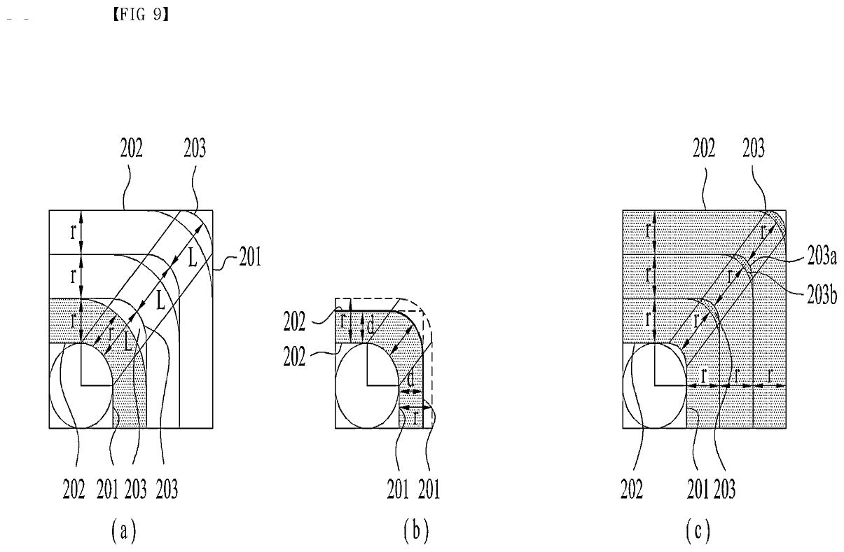

FIG. 9 shows a configuration of the laundry treating apparatus that maintains a spacing between curved ribs or radii of curvature of the curved ribs.

As described above, in order to generate the uniform magnetic field in the region of the coil 600 corresponding to the curved ribs 203, the spacing between the portions of the respective windings of the coils 600 wound around the respective curved ribs 203 should be maximally constant in the outward direction, and an area in which the coil 600 is disposed for each unit area should be maximally constant in the outward direction.

Therefore, as shown in FIG. 9(a), maintaining the radii of curvature of the curved ribs 203 as a constant in the outward direction may allow for the coil 600 to heat the drum 30 more uniformly.

Because a diameter of the coil 600 is a first diameter r, a spacing between the first straight ribs 201 may correspond to a first diameter r, and a spacing between the second straight ribs 202 may correspond to a second diameter r. In this regard, the radii of curvature of the curved ribs 203 may be equal to each other to correspond to ¼ of an inner arc.

However, when the curved ribs 203 are manufactured to have the equal radius of curvature while maintaining the equal spacing between the first straight ribs 201 and between the second straight ribs 202, a spacing between an inner first curved rib 203 and an outer second curved rib 203 is an extended length L greater than the first diameter r.

Therefore, because there is a space between the curved ribs 203, the coil 600 wound around the curved ribs 203 may not be able to generate a uniform magnetic field because of shaking during vibration or may not be able to be fixed to the curved ribs 203, resulting in poor installation stability.

In order to reduce such problem, it may be considered to arrange curved ribs 203 to have an equal spacing of the first diameter r1, which is the diameter of the coil, as shown in FIG. 9(b).

In this case, a spacing between a curved rib 203 disposed at an inner side of the seating surface 120 and a curved rib 203 disposed at an outer side of the seating surface 120 corresponds to the first diameter r, so that the coil 600 may be stably fixed. However, a spacing between a first straight rib 201 extending from the inner curved rib 203 and a first straight rib 201 extending from the outer curved rib 203 is a reduced length d, which is smaller than the first diameter r, and a spacing between a second straight rib 202 extending from the inner curved rib 203 and a second straight rib 202 extending from the outer curved rib 203 is the reduced length d, which is smaller than the second diameter r.

Accordingly, the coil 600 including the first diameter r is not able to be formed between the first straight ribs 201 and between the second straight ribs 202. Therefore, in order to solve such problem, the present disclosure may provide the induction module I capable of maintaining the length of the coil 600 on both inner and outer sides while the arrangement of the coil 600 around the curved ribs 203 is uniform by varying a thickness of the curved rib 203.

Specifically, the curved rib 203 of the laundry treating apparatus 1 according to the present disclosure may have a thickness different from a thickness of at least one of the first straight rib and the second straight rib. For example, the curved rib 203 may have a portion with a thickness greater than that of the first straight rib 201 and the second straight rib 202.

The thickness of the curved rib 203 increases and then decreases from one end 2031 where the curved rib 203 is connected to the first straight rib 201 to an other end 2032 where the curved rib 203 is connected to the second straight rib 202, so that a spacing between the curved ribs 203 may be maintained as uniform. Thereby, allowing heat to be generated more uniformly.

Specifically, the curved rib 203 may have a central portion thicker than portions thereof connected to the first straight rib 201 and the second straight rib 202. In the curved rib 203, a radius of curvature of an outer surface 203b and a radius of curvature of an inner surface 203a may be different from each other. In the curved rib 203, the radius of curvature of the outer surface 203b may be smaller than the radius of curvature of the inner surface 203a.

Accordingly, shapes of the curved rib 203 disposed at the inner side of the seating surface 120 and the curved rib 203 disposed at the outer side of the seating surface 120 may be equal, and the spacings between the inner curved rib 203 and the outer curved rib 203 may also be equal. In addition, an inner surface 203a of the curved rib 203 disposed at the inner side of the seating surface 120 and an inner surface 203a of the curved rib 203 disposed at the outer side of the seating surface 120 may have the same radius of curvature. In addition, an outer surface 203b of the curved rib 203 disposed at the inner side of the seating surface 120 and an outer surface 203b of the curved rib 203 disposed at the outer side of the seating surface 120 may have the same radius of curvature. As a result, the spacing between the plurality of curved ribs 203 may be maintained at the first diameter r, and the windings of the coil 600 seated around the plurality of curved ribs 203 may be fixed to the plurality of curved ribs 203, thereby ensuring uniform spacing between windings of the coil 600.

In addition, windings of the coil 600 respectively wound around the inner curved rib 203 and the outer curved rib 203 may be spaced apart from each other by the equal spacing, and may have the same shape and the same length. As a result, the uniform magnetic field may be generated in the region of the base 100 where the curved ribs 203 are disposed, and the exclusion region in which the coil 600 is not disposed may be minimized, so that the drum 30 may be heated more uniformly by the coil 600.

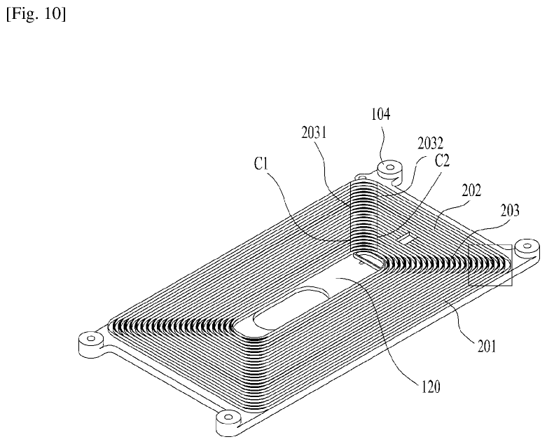

FIG. 10 shows a base structure on which curved ribs to which the configuration of the laundry treating apparatus of FIG. 9 is applied.

The radii of curvature of the outer surfaces 203b of the curved ribs 203 spaced apart from each other in the outward direction of the seating surface 120 may be equal to each other, and the radii of curvature of the inner surfaces 203a of the curved ribs 203 spaced apart from each other in the outward direction of the seating surface 120 may be equal to each other. Additionally, the curved ribs 203 spaced apart from each other in the outward direction of the seating surface 120 may have the same length or width. As a result, the curved ribs 203 spaced apart from each other in the outward direction of the seating surface 120 may have the same shape, which allows for more uniform heating of the drum 30.

Accordingly, an extended line of ends 2031 at one side where the curved ribs 203 spaced apart from each other in the outward direction of the seating surface 120 are connected to the first straight ribs 201 may form a first straight line C1 with the first straight rib 201, and an extended line of the other ends 2032 where the curved ribs 203 spaced apart from each other in the outward direction of the seating surface 120 are connected to the second straight ribs 202 may also form a second straight line C2 with the second straight rib 202.

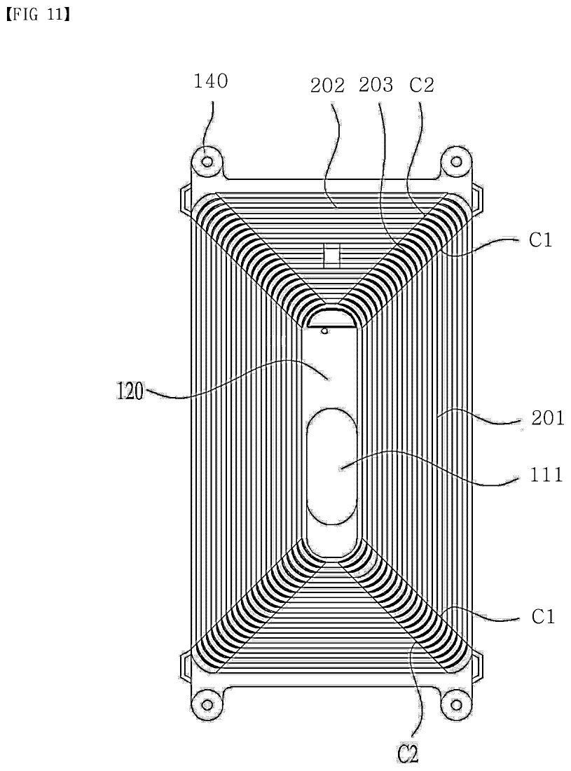

FIG. 11 is a top view of a base of an induction module of a laundry treating apparatus according to the present disclosure. When the inner and outer curved ribs 203 have the same shape, the first straight line C1 and the second straight line c2 may be disposed perpendicular to each other. Even when the lengths of the first straight ribs 201 are gradually shortened in the inward direction, and the lengths of the second straight ribs 202 are gradually shortened in the inward direction, an area of the region where the curved rib 203 is installed may be minimized.

In addition, because the region where the curved rib 203 is installed is uniformly formed in the outward direction, the uniform magnetic field may be generated in the inner and outer curved ribs 203. Accordingly, heat can be generated more uniformly by the windings of the coil 600 disposed in the curved rib 203.

In one example, an outer circumferential surface of the entire straight ribs 201 may have a trapezoidal shape, and an outer circumferential surface of the entire second straight ribs 202 may have a trapezoidal or triangular shape. In another example, an outer circumferential surface of the entire curved ribs 203 may have a bar shape having a uniform thickness.

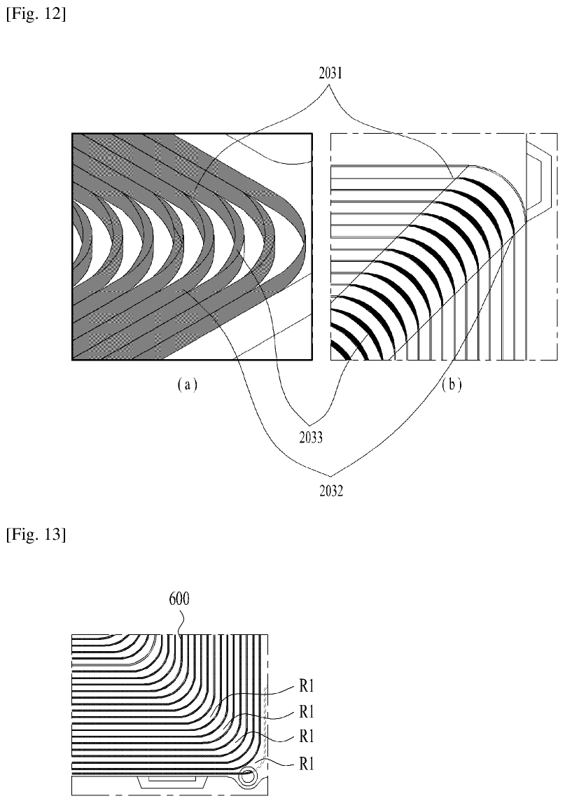

FIG. 12 shows curved ribs of an induction module of a laundry treating apparatus according to the present disclosure in detail. FIG. 12(a) is a perspective view of the curved ribs, and FIG. 12(b) is a top view of the curved ribs.

The curved rib 203 includes one end 2031 connected to the first straight rib 201, an other end 2032 connected to the second straight rib 202, and a central portion 2033 disposed between one end and the other end.

The one end 2031 may have a same thickness as the first straight rib 201, and the other end 2032 may have a same thickness as the second straight rib 202. However, the central portion 2033 may be thicker than the first straight rib 201 and the second straight rib 2020 in an entire region thereof. The central portion 2033 may be configured such that the thickness thereof increases and then decreases from one end 2031 to the other end 2032. Accordingly, the thickness of the central portion 2033 may be thicker than a thickness of both the one end 2031 and the other end 2032.

FIG. 13 shows a shape of the coil 600 wound around the curved ribs 203.

The plurality of curved ribs 203 may be spaced apart from each other by an equal spacing. Accordingly, inner and outer windings of the coil 600 wound around the curved ribs 203 may be arranged with equal spacing, thereby the coil 600 is configured to generate heat more uniformly. In addition, in the plurality of curved ribs 203, one curved rib may have the same length and the same shape as and a curved rib disposed inwardly or outwardly of the curved rib. Accordingly, the inner and outer windings of the coil 600 wound around the curved ribs 203 may have the same length.

In addition, in the plurality of the curved ribs 203, one curved rib may have the same radius of curvature as and the curved rib disposed inwardly or outwardly of the curved rib. Specifically, the inner surfaces 203b of the plurality of curved ribs may have the same radius of curvature, and the outer surfaces 203a of the plurality of curved ribs may have the same radius of curvature. The radius of curvature of the outer surfaces 203a of the plurality of curved ribs may be greater than the radius of curvature of the inner surfaces 203b of the plurality of curved ribs to compensate for the radius of curvature that may increase outwardly.

As a result, the inner surfaces 203b of the plurality of curved ribs may have the same length and shape, and the outer surfaces 203a of the plurality of curved ribs may have the same length and shape. Accordingly, the inner and outer windings of the coil 600 wound around the curved ribs 203 may also form the equal radius of curvature R1. In addition, the inner and outer windings of the coil 600 wound around the curved ribs 203 may have the same length and shape. As a result, the coil 600 wound around the curved ribs 203 may deliver the uniform magnetic field to the drum 30.

The present disclosure may be implemented in various forms, so that the scope of the rights thereof is not limited to the above-described embodiment. Therefore, when the modified embodiment includes components of claims of the present disclosure, it should be regarded as belonging to the scope of the present disclosure.

1-16. (canceled)

17. A laundry treating apparatus comprising:
a cabinet having an inlet disposed in a front surface thereof;
a tub having a tub inlet disposed therein and facing the inlet of the cabinet, the tub being configured to accommodate water therein;
a drum disposed inside the tub, the drum being configured to accommodate laundry therein;
a driver including a rotation shaft coupled to a rear of the tub and configured to rotate the drum; and
an induction module coupled to an outer circumferential surface of the tub, the induction module being configured to form a magnetic field for heating the drum,
wherein the induction module includes:
a base coupled to the outer circumferential surface; and
a coil configured to generate the magnetic field,
wherein the coil is wound on the base,
wherein the base includes:
a seating surface fixed to the outer circumferential surface of the tub;
a plurality of first straight ribs extending along a front and rear direction on the seating surface and spaced apart from each other in an outward direction of the seating surface;
a plurality of second straight ribs extending along a width direction on the seating surface and spaced apart from each other in the outward direction of the seating surface; and
a plurality of curved ribs, each of the plurality of curved ribs connecting a first straight rib and a second straight rib adjacent thereto to each other,
wherein each of the plurality of curved ribs has a thickness different from a thickness of at least one of the first straight rib and the second straight rib, and
wherein the coil is wound around the plurality of first straight ribs, the plurality of second straight ribs, and the plurality of curved ribs.

18. The laundry treating apparatus of claim 17, wherein each of the plurality of curved ribs has a portion having a greater thickness than the thickness of the first straight rib and the second straight rib.

19. The laundry treating apparatus of claim 17, wherein each of the plurality of curved ribs has a central portion thicker than end portions thereof connected to each of the adjacent first straight rib and the adjacent second straight rib.

20. The laundry treating apparatus of claim 19, wherein the thickness of each of the plurality of curved ribs increases and then decreases while extending from the adjacent first straight rib to the adjacent second straight rib, respectively.

21. The laundry treating apparatus of claim 17, wherein radii of curvature of an outer surface and an inner surface of each of the plurality of curved ribs are different from each other.

22. The laundry treating apparatus of claim 21, wherein each of the plurality of curved ribs has a smaller radius of curvature of the outer surface than a radius of curvature of the inner surface.

23. A laundry treating apparatus comprising:
a cabinet having an inlet disposed in a front surface thereof;
a tub having a tub inlet disposed therein and facing the inlet of the cabinet, the tub being configured to accommodate water therein;
a drum disposed inside the tub, the drum being configured to accommodate laundry therein;
a driver including a rotation shaft coupled a rear of the tub and configured to rotate the drum; and
an induction module coupled to an outer circumferential surface of the tub, the induction module being configured to form a magnetic field for heating the drum,
wherein the induction module includes:
a base coupled to the outer circumferential surface; and
a coil configured to generate the magnetic field,
wherein the coil is wound on the base,
wherein the base includes:
a seating surface fixed to the outer circumferential surface of the tub;
a plurality of first straight ribs extending along a front and rear direction on the seating surface and spaced apart from each other in an outward direction of the seating surface;
a plurality of second straight ribs extending along a width direction on the seating surface and spaced apart from each other in the outward direction of the seating surface; and
a plurality of curved ribs, each of the plurality of curved ribs connecting a first straight rib and a second straight rib adjacent thereto to each other,
wherein, in the plurality of curved ribs, a radius of curvature of a curved rib disposed at an outer side of the seating surface is less than a radius of curvature of a curved rib disposed at an inner side of the seating surface, and
wherein the coil is wound around the plurality of first straight ribs, the plurality of second straight ribs, and the plurality of curved ribs.

24. The laundry treating apparatus of claim 23, wherein a radius of curvature of an inner surface of the curved rib disposed at the inner side of the seating surface and a radius of curvature of an inner surface of the curved rib disposed at the outer side of the seating surface are equal to each other.

25. The laundry treating apparatus of claim 23, wherein a radius of curvature of an outer surface of the curved rib disposed at the inner side of the seating surface and a radius of curvature of an outer surface of the curved rib disposed at the outer side of the seating surface are equal to each other.

26. The laundry treating apparatus of claim 23, wherein a length of the curved rib disposed at the inner side of the seating surface and a length of the curved rib disposed at the outer side of the seating surface are equal to each other.

27. The laundry treating apparatus of claim 26, wherein a shape of the curved rib disposed at the inner side of the seating surface and a shape of the curved rib disposed at the outer side of the seating surface are the same.

28. The laundry treating apparatus of claim 23, wherein an extended line of one end of the plurality of curved ribs forms a first straight line, and
wherein an extended line of an other end of the plurality of curved ribs forms a second straight line perpendicular to the first straight line.

29. The laundry treating apparatus of claim 28, wherein a spacing between the one end of the plurality of curved ribs and the other end of the plurality of curved ribs is maintained in the outward direction of the seating surface.

30. The laundry treating apparatus of claim 23, wherein the first straight rib and the second straight rib are constructed such that lengths thereof increase in the outward direction of the seating surface.

31. A laundry treating apparatus comprising:
a cabinet having an inlet disposed in a front surface thereof;
a tub having a tub inlet disposed therein and facing the inlet of the cabinet, the tub being configured to accommodate water therein;
a drum disposed inside the tub, the tub being configured to accommodate laundry therein;
a driver including a rotation shaft coupled to a rear of the tub and configured to rotate the drum; and
an induction module coupled to an outer circumferential surface of the tub, the induction module being configured to form a magnetic field for heating the drum,
wherein the induction module includes:
a base coupled to the outer circumferential surface; and
a coil configured to generate the magnetic field,
wherein the coil is wound on the base,
wherein the base includes:
a seating surface fixed to the outer circumferential surface of the tub;
a plurality of first straight ribs extending along a front and rear direction on the seating surface and spaced apart from each other in an outward direction of the seating surface;
a plurality of second straight ribs extending along a width direction on the seating surface and spaced apart from each other in the outward direction of the seating surface; and
a plurality of curved ribs, each of the plurality of curved ribs connecting a first straight rib and a second straight rib adjacent thereto to each other,
wherein the first straight rib and the second straight rib are constructed such that lengths thereof increase in the outward direction of the seating surface, and
wherein the coil is wound around the plurality of first straight ribs, the plurality of second straight ribs, and the plurality of curved ribs.

32. The laundry treating apparatus of claim 31, wherein lengths of the first straight rib and the second straight rib increase at a predetermined rate in the outward direction of the seating surface.

33. The laundry treating apparatus of claim 32, wherein a length of a shortest first straight rib is larger than a length of a shortest second straight rib.

34. The laundry treating apparatus of claim 31, further comprising:
a first and second plurality of first straight ribs which are disposed to be parallel to each other; and
a first and second plurality of second straight ribs which are disposed to be parallel to each other.

35. The laundry treating apparatus of claim 34, wherein the seating surface further comprises an air passing hole, and
wherein the air passing hole is interposed between the first and second plurality of first straight ribs and the first and second plurality of second straight ribs.

36. The laundry treating apparatus of claim 34, wherein the plurality of curved ribs connect the first and second plurality of first straight ribs to the first and second plurality of second straight ribs.
